(19) United States
(12) Patent Application Publication
(10) Pub. No.: US 2011/0168336 A1
(43) Pub. Date: Jul. 14, 2011

(54) Arched Shade

(76) Inventors: David M. Kenyon, St. Louis, MO (US); Ryan K. Lohmeier, Cape Girardeau, MO (US)

(21) Appl. No.: 13/006,707

(22) Filed: Jan. 14, 2011

Related U.S. Application Data
(60) Provisional application No. 61/295,156, filed on Jan. 14, 2010.

(51) Int. Cl. A47H 23/04; B23P 11/00

(52) U.S. Cl. 160/84.07; 29/428

(57) ABSTRACT

An arch-shaped shade has a channel, an insert and a pleated sheet with at least one of the pleats sandwiched between the insert and the channel, and the opening in the channel is narrower than the sandwiched pleated sheet. The arch-shaped shade can be formed in a fixed open position or can be foldable with a hinge in the center. The channel can have various configurations, and various types of corresponding inserts can slide into the channel.

### CROSS-REFERENCE TO RELATED APPLICATIONS

This application claims priority from U.S. Provisional Patent Application No. 61/295,156 filed on Jan. 14, 2010.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to shades, and more particularly to shades having an arched shape.

2. Related Art

Various inventions on arch-shaped shades are described in U.S. Pat. Nos. 5,139,070, 5,662,153, 6,145,569, and 7188658 and in US Patent App, Pub. No. US20090293400. These references show several different constructions for arch-shaped shades that are currently known, but none of these references show or suggest the construction for the arch-shaped shade of the present invention nor do these references disclose or suggest the method for producing the arch-shaped shade according to the method of manufacture for the present invention.

### SUMMARY OF THE INVENTION

The arch-shaped shade of the present invention has a channel, an insert and a pleated sheet with at least one of the pleats sandwiched between the insert and the channel. According to different embodiments of the invention, the arch-shaped shade can be formed in a fixed open position or can be foldable with a hinge in the center. For both embodiments of the invention, the channel can have various configurations, and various types of corresponding inserts can slide into the channel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a front elevation view of the arch-shaped shade in a fixed open embodiment;

FIGS. 1B-1C are side cut-way views of the arch-shaped shade;

FIG. 2A is a front elevation view of the arch-shaped shade in a rotatable embodiment in its fanned-out arrangement;

FIGS. 2B and 2C are partial front elevation view of the arch-shaped shade in a rotatable embodiment in its folded-in arrangement; and

FIG. 2D is a side cut-away view of the arch-shaped shade shown of FIG. 2C.

FIGS. 3 and 4 are isometric views of the present invention in the fabrication process.

### DETAILED DESCRIPTION OF THE PREFERRED EMBODIMENTS

The following description of the preferred embodiment(s) is merely exemplary in nature and is in no way intended to limit the invention, its application, or uses.

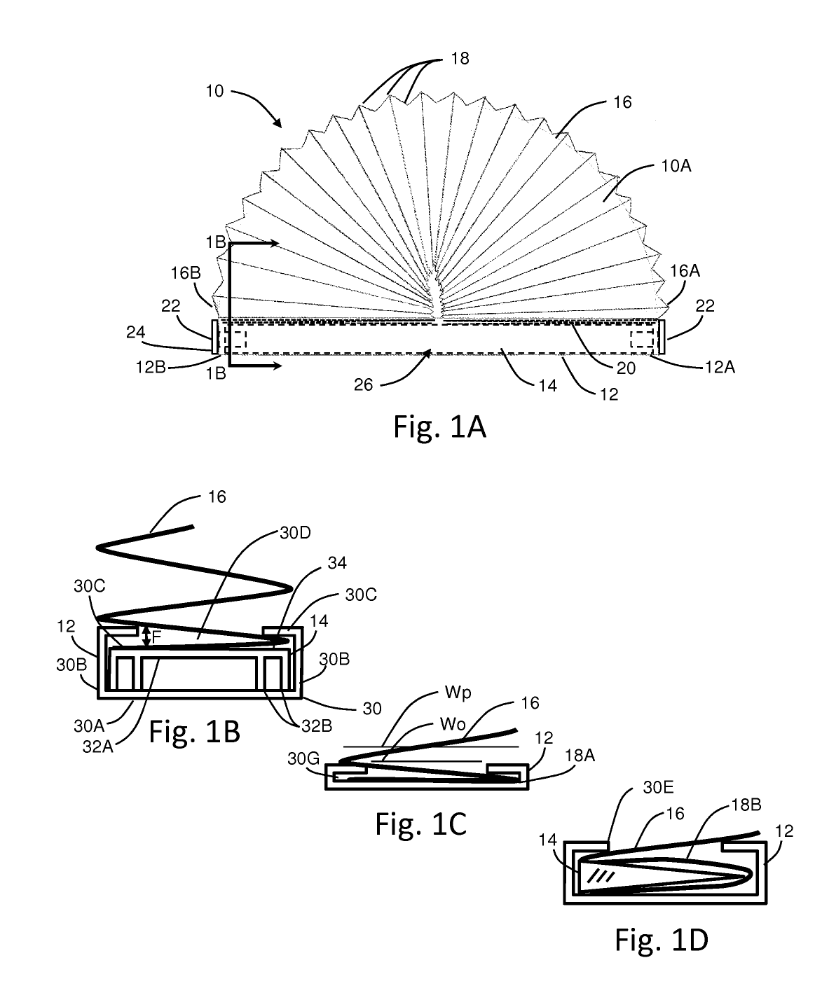

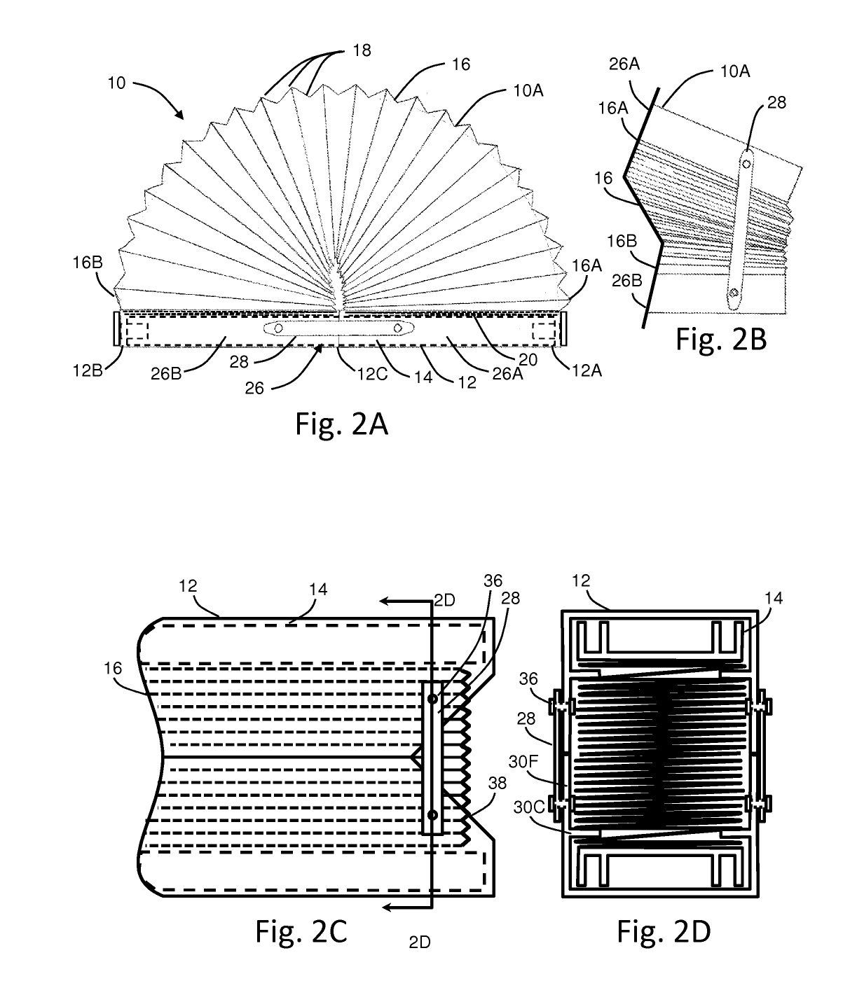

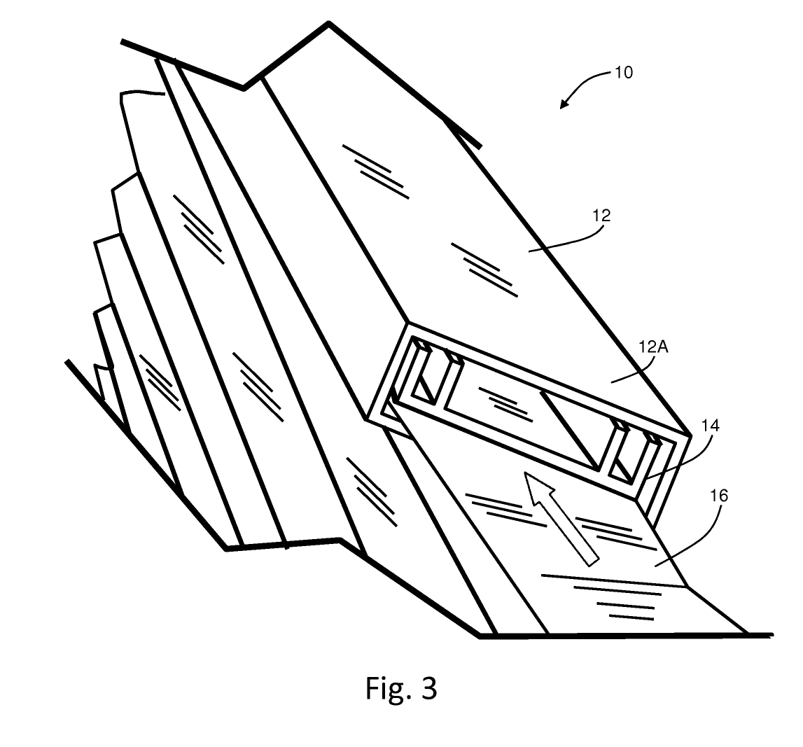

As illustrated in FIGS. 1 and 2, the arch-shaped shade 10 of the present invention has an elongated channel 12 and an insert 14 that fits within the channel. A pleated sheet 16 fans out between adjacent channel sections extending to the channel's respective ends 12A, 12B. At each end of the pleated sheet 16A, 16B, one or more of the pleats 18, is sandwiched between the channel 12 and the insert 14. As discussed in more detail below, the pleats are preferably held in place between the channel 12 and the insert 14 through a friction-fit arrangement 20. At each end of the channel, a cap 22 is pressed into the channel 12 in a snap-fit arrangement 24 to keep the insert 14 and the pleated sheet 16 from sliding out the ends 12A, 12B. Together, the channel 12 and the insert 14 form the base rail 26 of the shade 10.

As illustrated in FIG. 1, one embodiment of the arch-shaped shade 10 has a continuous base rail 26 extending between the ends 12A, 12B so that the shade has a fixed open position in its fanned-out arrangement 10A. As illustrated in FIG. 2, a second embodiment includes a hinge 28 at the channel's center portion 12C between base rail sections 26A, 26B. The hinge 28 allows the shade to rotate between a closed position in its folded-in arrangement 10B as shown in FIG. 2B and the open position in its fanned-out arrangement 10A as shown in FIG. 2A. In the open position, the base rail sections 26A, 26B are in an aligned arrangement (26A_26B) with each other, and in the closed position, the base rail sections 26A, 26B are in an opposing arrangement with each other, preferably parallel to each other (26A∥26B).

As particularly illustrated in FIG. 1B, the channel 12 is preferably formed with a C-channel cross-section 30 with a base 30A, a pair of sides 30B extending away from the base, and a pair of lips 30C extending inwardly from the respective sides. In the preferred embodiments, the sides 30B are substantially perpendicular to the base 30A, and the pleats 18 fit between the lips 30C of the C-channel and the insert 14. The insert preferably has a platform surface 32A that is elevated from the base 30A within the channel 12 by a number of legs 32B. In general, the channel 12 is an elongated housing with an opening 30D extending between the ends 12A, 12B, and the lips 30C overhang the channel and reduce the width of the channel's opening 30D (Wo) from the width of the channel's sides (Ws) to be narrower than the width of the pleats (Wp) and thereby block the pleats from freely pulling out of the channel (Wo<Wp).

When the pleats are fit between the channel and the insert, they can act as a compression spring to further increase the friction of the pleats 18 between the insert's platform surface 14A and the C-channel's lips 30C. The bends 18A in the pleats 18 can produce a spring constant (K) which results in an outward force (F) in the space 34 between the insert and the channel. Also, some pleats 18 may have a curved shape 18B between the bends which would also have a spring constant resulting in an outward force. Additionally, the flexible material of the pleated sheet 16 can have some rigidity, such as sheets which are formed from plastic like polyethylene terephthalate (PET), and when the pleats 18 at the end of the sheet bend around the lip's edge 30E, the section of the pleats within the insert-channel space 32 press against the platform surface 14A.

In the preferred embodiments for the arch-shaped shade 10 discussed above, the insert 14 fills most of the depth in the C-channel structure 30 in order to provide for the friction-fit arrangement of the shade's pleats. It will be appreciated that there are a number of alternative arrangements between the channel and the insert. For example, as shown in FIG. 2D, the channel sides 30B may have walls 30F extending beyond the lips 30C so that the folded-in pleats are contained within the sides in the closed position for the folding version of the shade. Generally, the outer surface of the insert fits loosely within the inner surface of the channel. It will also be appreciated that the insert may be integrally formed with the C-channel or the lips may form a shallow space 30G in the C-channel so that one or more of the shade's pleats serve as the insert, such as shown in FIG. 1C. While a C-channel is the preferred cross-sectional shape for the channel 12 and the complementary insert is preferably rectangular in shape, it will be appreciated that other cross-sectional shapes could also be used where there are complementary surfaces, and that one of the shade's pleats may be wrapped around an insert within the channel, such as shown in FIG. 1D where the insert has a triangular cross-sectional shape.

As particularly shown in FIG. 2C for the foldable arched shade 10, the hinge is fixed in place by a fastener 36, such as a rivet or a bolt. In this configuration, the channel's center portion 12C has a notch 38 that allows the center portion to rotate more freely. It will be appreciated that the hinge can be concealed within the interior of the channel. It will also be appreciated that an alternative configuration could use a slotted sliding hinge.

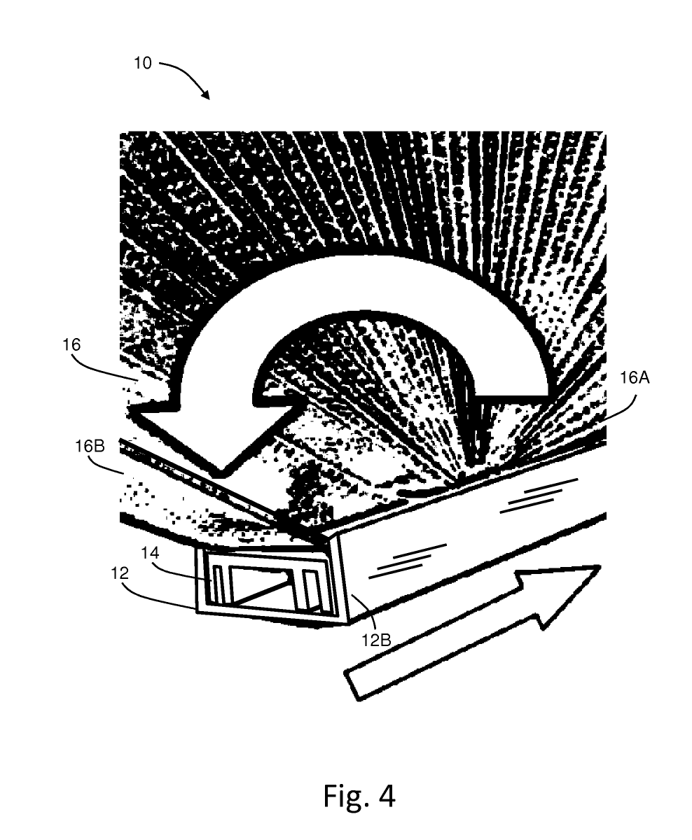

FIGS. 4 and 5 illustrate the method of manufacturing the arched shade 10 of the present invention. For fabricating the arched shade, the width of the pleated sheet 16 is approximately one-half of the total length of the base rail 26 from end 12A to end 12B. The pleated sheet may be cut to the proper width. The length of the pleated sheet when it is stretched out flat is approximately three (3) times the width of the base rail.

As particularly illustrated in FIG. 4, the insert 14 is slid into the C-channel 16 with the insert's platform surface 32A facing the C-channel's lips 30C (the open side of the C-channel). One or more pleats 18 of the pleated sheet 16 are slid into the space 34 between the insert's platform surface and the C-channel's lips. Other channel configurations may use one or more of the pleats of the pleated sheet as the insert or may have the pleated sheet wrapping around an insert and being slid into the C-channel together, such as the configurations respectively shown in FIG. 1C and FIG. 1D. Generally, the insert 14 is used to decrease the space 34 in which the pleats 18 are fitted.

In manufacturing the arched shade 10 that is in the fixed open position, shown in FIG. 1, the pleated sheet 16 is slid entirely into the channel 12. As shown in FIG. 5, it is preferred to slide the first end of the sheet 16A from the one channel end 12A where it enters almost to the other end 12B where the other end of the sheet 16B enters the channel 12. When the first end 12A is slid into the channel 12, the free end of the sheet 16B is arched over the first end of the sheet 16A and inserted in a manner similar to the first end of the sheet 16A at the opposite end of the channel 12B. As with the first end of the sheet 16A, one or more pleats 18 at the other end of the sheet 16B are slid into the space 34 between the insert's platform surface 32A and the C-channel's lips 30C. As the second end 16B is inserted into the channel 12, the first end of the sheet 16A is slid back towards its end of the channel 12A until the arched pleated sheet 16 is centered in the channel 12.

The manufacture of the foldable arched shade 10, shown in FIG. 2, also has a step of attaching the hinges 28 at the channel's center portion 12C. The fabrication process of the foldable arched shade can be the same as the fixed open shade when the hinges are attached before the pleated sheet 16 is slid into the channel 12. The foldable arched shade also has an alternative fabrication process when the hinges are attached after the pleated sheet 16 is slid into the channel. In this alternative process, the free end of the sheet 16B does not need to be arched over the first end of the sheet 16A when sliding the pleats 18 into the channel 12.

To complete the fabrication process, the end plugs 22 are inserted at both ends 12A, 12B of the channel, and the arched shade 10 is ready for fastening. The arched shade can be inserted into an arched window frame and attached to the frame by placing double sided adhesive tape on the bottom side of the channel. Holes can be drilled into the channel which can be attached to the window frame with screws.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An arch-shaped shade, comprising:
an elongated channel extending between a first end and a second end;
an insert fitting within said channel between said first end and said second end; and
a pleated sheet comprising a plurality of pleats extending between said first end and said second end of said elongated channel, wherein at least one of said pleats at said first end is sandwiched between said channel and said insert, wherein at least one of said pleats at said second end is sandwiched between said channel and said insert, and wherein said pleats are in a fanned out arrangement between said first end and said second end.

2. The shade of claim 1, wherein said elongated channel is further comprised of a first section at said first end, a second section at said second end and a hinge at a center portion of said elongated channel between said first end and said second end, wherein said hinge connects said first section in a rotatable manner relative to said second section between an open position and a closed position, said open position comprising said first section aligned with said second section with said pleats in said fanned out arrangement from said center portion, and said closed position comprising said first section opposed to said second section with said pleats in a folded in arrangement between said first section and said second section.

3. The shade of claim 2, wherein said channel is further comprised of a C-channel with a base, a pair of sides extending from said base, and a pair of lips extending inwardly from said respective sides and forming an opening with a width less than a width of said sandwiched pleat.

4. The shade of claim 3, wherein each of said sides further comprises a wall extending substantially perpendicular from said base beyond said lips and wherein said pleats in said folded in arrangement fit within said walls.

5. The shade of claim 3, wherein said sides further comprise a notch proximate to said center portion.

6. The shade of claim 1, wherein said channel is further comprised of a C-channel with a base, a pair of sides extending from said base, and a pair of lips extending inwardly from said respective sides and forming an opening with a width less than a width of said sandwiched pleat.

7. The shade of claim 6, wherein said insert is comprised of a platform and a plurality of legs, wherein said legs elevate said platform from said base within said channel and wherein said channel comprises a space between said lips and said platform for said sandwiched pleats.

8. The shade of claim 6, wherein said insert is integrally formed with said channel.

9. The shade of claim 6, wherein said pair of lips form a shallow space in said channel and wherein a plurality of pleats are fit within said channel, wherein at least one of said pleats forms said insert and said sandwiched pleat extends through said opening and bends around an edge of at least one of said lips.

10. The shade of claim 1, further comprising a first end cap fitted into said channel at said first end of said channel and a second end cap fitted into said channel at said second end of said channel.

11. An arch-shaped shade, comprising:
an elongated channel comprising a first channel section and a second channel section extending between a first end and a second end, wherein each of said first channel section and said second channel section comprises a base, a pair of sides extending from said base and a pair of lips extending inwardly from said pair of sides and forming an opening with a width;
an insert fitting within said channel between said first end and said second end, wherein said insert comprises a platform surface between said base and said lips; and
a pleated sheet comprising a plurality of pleats extending between said first end and said second end of said elongated channel, wherein at least one of said pleats at said first end is sandwiched between said channel and said insert, wherein at least one of said pleats at said second end is sandwiched between said channel and said insert, wherein said sandwiched pleats have a width greater than the opening width, and wherein said pleated sheet are in a fanned out arrangement between said first end and said second end.

12. The shade of claim 11, further comprising a hinge at a center portion of said elongated channel, wherein said hinge connects said first channel section in a rotatable manner relative to said second channel section between an open position and a closed position, said open position comprising said first channel section substantially aligned with said second channel section with said pleats in a fanned out arrangement, and said closed position comprising said first channel section substantially parallel to said second channel section with said pleats in a folded in arrangement between said first channel section and said second channel section.

13. The shade of claim 12, wherein each of said sides further comprises a wall and a notch proximate to said center portion, wherein said walls are extend substantially perpendicular from said base beyond said lips and wherein said pleats in said folded in arrangement fit within said walls.

14. The shade of claim 11, wherein said insert is further comprised of a plurality of legs elevating said platform from said base within said channel.

15. The shade of claim 11, wherein said insert is integrally formed with said channel.

16. A method of making an arch-shaped shade, comprising the steps of:
providing a channel having a first section and a second section, wherein each of said first section and said second section are comprised of a base, a pair of sides extending from said base and a pair of lips extending inwardly from said pair of sides to form an opening with a width;
sliding at least one pleat from a first end of a pleated sheet into said first section of said channel, wherein said pleat has a width greater than the opening width;
fanning out said pleated sheet; and
sliding at least another pleat from a second end of a pleated sheet into said second section of said channel.

17. The method of claim 16 further comprising the step of sliding an insert into said channel, wherein said pleats are sandwiched between said insert and said channel.

18. The shade of claim 17, wherein said first channel section is formed apart from said second channel section, and further comprising the steps of sliding a first insert into said first channel section and a second insert into said second channel section and connecting said first channel section to said second channel section with a hinge.

19. The shade of claim 16, wherein said step of sliding said insert into said channel is performed before sliding said pleats into said channel.

20. The shade of claim 16, wherein said step of sliding said pleat from a first end of said pleated sheet, further comprises sliding said pleat from said first section of said channel into said second channel before fanning out said pleated sheet.
